(19) United States
(12) Patent Application Publication
(10) Pub. No.: US 2013/0256982 A1
(43) Pub. Date: Oct. 3, 2013

(54) IMAGE FORMING APPARATUS

(71) Applicants: Yusuke KAWANAGO, Tokyo (JP); Takahiro OKUBO, Tokyo (JP); Masahiro MATSUO, Tokyo (JP); Haruki MOTEGI, Tokyo (JP)

(72) Inventors: Yusuke KAWANAGO, Tokyo (JP); Takahiro OKUBO, Tokyo (JP); Masahiro MATSUO, Tokyo (JP); Haruki MOTEGI, Tokyo (JP)

(73) Assignee: KONICA MINOLTA BUSINESS TECHNOLOGIES, INC., Tokyo (JP)

(21) Appl. No.: 13/847,032

(22) Filed: Mar. 19, 2013

(30) Foreign Application Priority Data
Apr. 2, 2012 (JP) 2012-84009

(51) Int. Cl. B41J 13/00

(52) U.S. Cl. CPC B41J 13/0045
USPC 271/225

(57) ABSTRACT

The control portion controls the sheet adjusting portion to alternately convey the sheet of paper fed from the sheet-feeding path for single-side printing and the sheet of paper fed from the sheet-feeding path for duplex printing to the image forming portion during the duplex printing mode. Images are alternately formed on the front surface of each of the sheets of paper and the back surface of each of the sheets of paper when three sheets of paper are conveyed to the image forming apparatus and they are left therein. The control portion controls the sheet conveying portion to release the contact of the conveying rollers after it is detected that the sheet of paper reaches the sheet adjusting portion.

### CROSS REFERENCE TO RELATED APPLICATION

This application is based on Japanese Patent Application No. 2012-84009 filed with Japanese Patent Office on Apr. 2, 2012, the entire contents of which being hereby incorporated by reference.

### BACKGROUND OF THE INVENTION

1. Field of the Invention

The present invention relates to an image forming apparatus which is applied to a color printer, a black/white printer, a copying machine, a multifunction printer thereof or like.

2. Description of Related Art

In the recent year, the image forming apparatus provided with duplex printing mode, under which images are formed on both the front and back surfaces of a sheet of paper, has been often used.

The image forming apparatus has a sheet adjusting portion in which a forward end of a sheet of paper hits against a nip portion formed of a pair of registration rollers so that its posture can be corrected toward a direct ion that is almost perpendicular to a sheet-conveying direction. The nip portion is then moved along a sheet-width direction with nipping the sheet of paper so that a position of the sheet of paper can be adjusted. In this condition, the sheet of paper is conveyed to a transfer portion (registration function).

For example, Japanese Patent Application Publication No. 2007-022680 has disclosed a paper aligning apparatus that has such a registration function.

This paper aligning apparatus has a pair of registration rollers, a pair of upper rollers and moving means. The moving means moves the pair of registration rollers to a direction which is perpendicular to a sheet-conveying direction with the pair of registration rollers nipping a sheet of paper and the pair of upper rollers being free. The pair of upper rollers is kept released during the registration operation.

### SUMMARY OF THE INVENTION

The image forming apparatus that has such a registration function and a registration-rollers-moving function, however, has a U-turn conveying route with a large radius of curvature and a sheet conveying portion on which conveying rollers and a motor therefor are provided. The sheet of paper passing through the U-turn conveying route with a large radius of curvature has high, conveying resistance and a low coefficient of friction (μ) for roller, on which wax contained toner exert an influence.

Thus, clamping (nipping) pressure by the conveying rollers is set so as to become higher than that of general conveying rollers. Further, the motor drives a contact/release mechanism but is placed the heavier load than is usual. In this circumstance, when the pair of registration rollers is moved using the moving mechanism described in line above Japanese Patent Application Publication No. 2007-022680 to correct the deflection of the sheet of paper, a release of the conveying rollers may be required in addition to a release of the pair of upper rollers.

On the other hand, when the pair of registration rollers is moved during an interval (sheet interval T) between the conveyed sheets of paper at the moment of continuously forming images on the back surfaces, torque applied, to the motor in the contact/release mechanism when contacting or releasing the conveying rollers with higher contact pressure is increased so that the motor may be stepped out. Here, the term, “step-out” of the motor is referred to as such phenomenon that when a load more than a certain level is applied to the motor during a period of operative time thereof, the motor can no longer be rendered operative and returned even if the load is removed.

Also, although it is conceivable that a period of operative time for contact/release is set so as to be longer, it has its limits to set the period of operative time for contact/release so as to be longer in order to render driven roller contacted with driving roller before next sheet of paper has reached the conveying rollers while maintaining its productivity.

By the way, it is also conceivable to set the period of time for contact/release so as to be longer by adding sufficient timeβto the sheet interval T between the conveyed sheets of paper in order to keep the period of time for contact/release in the sheet conveying portion long. An interval between the sheet of paper fed from the sheet-feeding path for duplex printing to a sheet adjusting portion and the next sheet conveyed fed from the sheet-feeding path for duplex printing to the sheet adjusting portion becomes long so that productivity of the image forming portion is reduced in the duplex printing mode.

This invention addresses the above-mentioned issues and has an object to provide an improved image forming apparatus that is capable of preventing a motor from being stepped out in the sheet conveying portion and allowing productivity of the image forming portion to be maintained by devising a sheet conveying method from the sheet adjusting portion to the image forming portion during the duplex printing mode.

To achieve at least one of the above-mentioned objects, an image forming apparatus reflecting one aspect of the present invention comprises an image forming portion that forms an image on a sheet of paper, a first route that feeds the sheet of paper to the image forming portion, a second route that feeds again the sheet of paper, a surface of which the image is formed, to the image forming portion, a sheet adjusting portion that adjusts a deflection of the sheet of paper along a sheet-width direction that is perpendicular to a sheet conveying direction of the sheet of paper fed to the usage forming portion, a sheet conveying portion that conveys the sheet of paper, a surface of which the image is formed, to the sheet adjusting portion by conveying rollers, the sheet conveying portion being provided on the second route at an upstream side of the sheet adjusting portion, and a control portion that is configured to control the sheet adjusting portion and the sheet conveying portion, wherein, during a duplex printing mode, the control portion controls the sheet adjusting portion to alternately feed the sheet of paper fed from the first route and the sheet of paper fed from the second route to the image forming portion and the control portion controls the sheet conveying portion to release the contact of the conveying rollers after it is detected that the sheet of paper reaches the sheet adjusting portion.

It is desirable to provide the image forming apparatus, as a second aspect of the present invention, according to the first aspect of the present invention wherein the control portion controls the image forming portion to alternately form an image on a surface of the sheet of paper fed from the first route and an image on the other surface of the sheet of paper fed from the second route.

It is also desirable to provide the image forming apparatus, as a third aspect of the present invention, according to the first aspect of the present invention further comprising a sheet detecting portion that detects a rear end of the sheet of paper, the sheet detecting portion being provided at upstream side of the sheet conveying portion, wherein the control portion the sheet conveying portion to contact the conveying rollers based on sheet-rear-end-detection information by the sheet detecting portion.

It is further desirable to provide the image forming apparatus, as a fourth aspect of the present invention, according to the third aspect of the present invention wherein the sheet adjusting portion includes a pair of registration rollers and a pair of loop rollers; and a forward end of the sheet of paper nipped by the loop rollers hits against a nipping portion formed of the pair of registration rollers correct the deflection of the sheet of paper.

It is additionally desirable to provide the image forming apparatus, as a fifth aspect of the present invention, according to the fourth aspect of the present invention wherein the pair of registration rollers includes a moving mechanism that moves the sheet of paper along the sheet-width direction that is perpendicular to the conveying direction of the sheet of paper with the sheet of paper being nipped.

It is still further desirable to provide the image forming apparatus, as a sixth aspect of the present invention, according to the first suspect of the invention wherein the sheet adjusting portion includes plural pairs of conveying rollers, and one pair of conveying rollers is driven independently of the other pair of conveying rollers and the sheet adjusting portion adjusts the deflection of the sheet of paper nipped by the plural pairs of conveying rollers.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing (s) wherein like reference characters refer to like elements.

### BRIEF DESCRIPTION OF THE DRAWINGS

FIG. 1 is a sectional view of an image forming apparatus relating to related art showing a configuration example thereof;

FIGS. 2A through 2E are diagrams showing a case where four sheets of paper are left in the image forming apparatus relating to related art and images are successively formed on front surfaces of the sheets of paper and back surfaces of the sheets of paper and inconvenience thereof;

FIG. 3 is a sectional view of an image forming apparatus according to an embodiment of this invention showing a configuration example thereof;

FIG. 4 is a perspective view of a sheet conveying portion showing a configuration example thereof;

FIG. 5 is a front view of a contact/release mechanism of the sheet conveying portion showing an operation example thereof;

FIG. 6A is a partially unfolded front view of a deflection correction portion showing a configuration example and a operation example thereof;

FIG. 6B is a partially unfolded top view of the deflection correction portion showing a configuration example and a operation example thereof;

FIG. 7A is a sectional view of an image forming apparatus relating to an embodiment of the invention showing a case where when three sheets of paper are conveyed and left in the image forming apparatus, the conveying rollers are released;

FIG. 7B is a sectional view of the image forming apparatus relating to the embodiment of the invention shoving a case where when three sheets of paper are conveyed and left in the image forming apparatus, the conveying rollers are contacted to each other;

FIG. 8 is a block diagram of a control system of the image forming apparatus relating to the embodiment of the present invention showing a configuration example thereof; and

FIGS. 9A through 9D are diagrams showing a case where three sheets of paper are left in the image forming apparatus relating to the embodiment of the present invention roof an operation example when images are alternately formed on front and back surfaces of the sheets of paper.

### DETAILED DESCRIPTION OF THE PREFERRED EMBODIMENTS

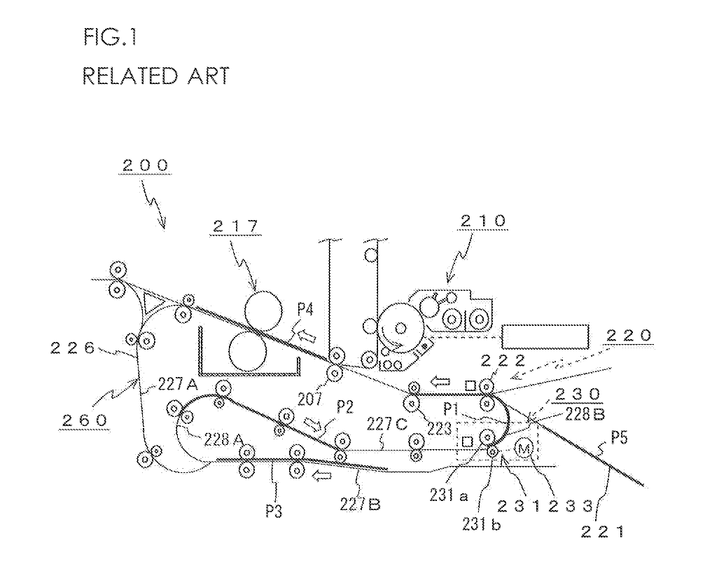

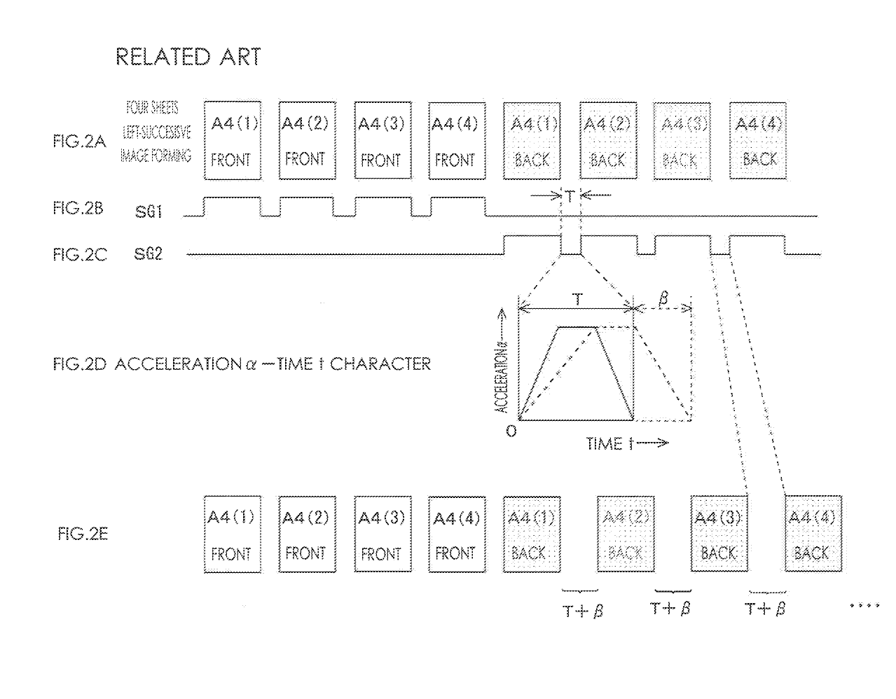

First, an image forming apparatus relating to related art will be explained with reference to FIGS. 1 through 2E. FIG. 1 shows a configuration example of an image forming apparatus 200 relating to related art. The image forming apparatus 200 shown in FIG. 1 contains a transfer portion 207, an image forming portion 210, a sheet adjusting portion 220, a sheet-feeding path 221 for single-side printing through which a sheet of pager is passed in a case of single-side printing mode or the like, a sheet-feeding path 226 for duplex printing through which a sheet of paper is passed in a case of duplex printing mode or the like, a sheet conveying portion 230 and a sheet-inversion mechanism 260.

The sheet-feeding path 221 for single-side printing is a sheet-feeding route extending from a sheet-feeding portion, not shown, to the sheet adjusting portion 220 and conveying a sheet of paper P to an image forming position (a transfer position) when forming the image on one side (front surface) of the sheet of paper P. The sheet-feeding path 226 for duplex printing is a sheet-feeding route extending from the sheet adjusting portion 220 to the sheet-inversion mechanism 260 and the sheet conveying portion 230 through the image forming portion 210 and back to the sheet adjusting portion 220.

The sheet-inversion mechanism 260 includes a circular sheet-feeding path 227A, an inverse sheet conveying path 227B and a sheet-feeding path 227C. The circular sheet-feeding path 227A is positioned at a downstream side of the fixing device 217 and the inverse sheet conveying path 227B is positioned at a downstream side of the circular sheet-feeding path 227A. To the inverse sheet conveying path 227B, the sheet-feeding path 227C is continuously connected. U-turn sheet conveying paths 228A and 228B each having large radius of curvature are positioned at the beginning of the sheet-feeding path 227C and the end thereof.

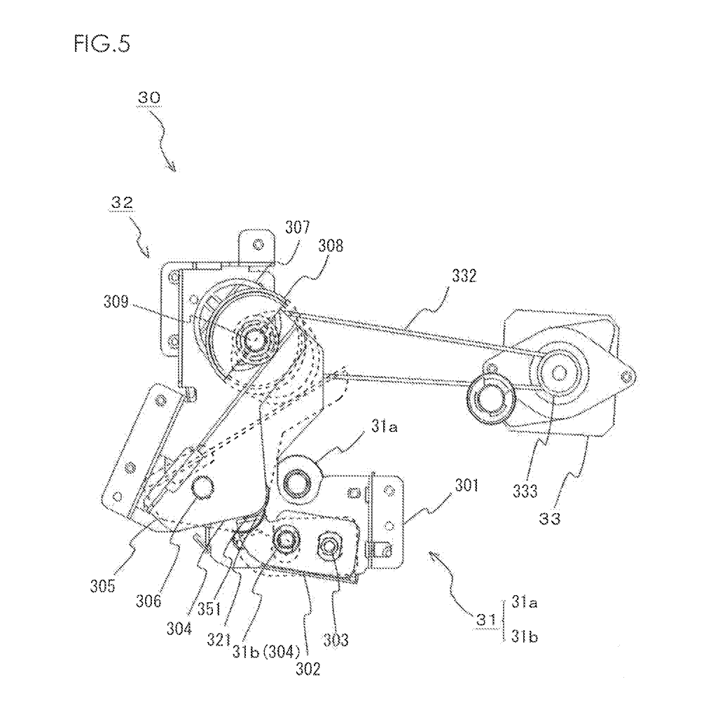

At the U-turn sheet conveying path 228B, the sheet conveying portion 230 is provided. The sheet conveying portion 230 contains conveying rollers 231, contact/release mechanism (see FIG. 5) and a motor. The conveying rollers 231 are composed of driving rollers 231a and driven rollers 231b. The contact/release mechanism contacts or releases the conveying rollers 31 having a high contact pressure. The sheet adjusting portion 220 is positioned between the sheet conveying portion 230 and the image forming portion 210. The sheet adjusting portion 220 contains a pair of loop rollers 222 and a pair of registration rollers 223.

In the sheet adjusting portion 220, a forward end of the sheet of paper P hits against a nip portion formed of the pair of registration rollers 223 by a rotation of the pair of loop rollers 222 just before the image formation so that a posture of the sheet of paper P can be corrected toward a direction that is almost perpendicular to a sheet-conveying direction. The pair of registration rollers 223 is then moved along a sheet-width direction with the sheet of paper P being nipped by the nipping portion by the pair of registration rollers 223 so that a position of the sheet of paper P can be adjusted. In this condition, the sheet of paper P is conveyed to the transfer portion 207 (registration function).

In such an image forming apparatus 200, during the duplex printing mode, four sheets of paper P1 through P4 may be left in the sheet-feeding path 226 for duplex printing. In this moment, the sheet of paper P1, on a front surface of which an image has been already formed, waits for forming an image on its back surface. The conveying rollers 231 have been already released.

In this embodiment, the sheet of paper P1 is left on a route from the sheet-feeding path 227C to the pair of loop rollers 222. The forward end of the sheet of paper P1 is nipped by the pair of loop rollers 222 and the rear end thereof is left at an upstream side of the U-turn sheet conveying path 228B. In such a condition, the sheet of paper P1 waits for forming an image on the back surface thereof. The sheet of paper P2, on a front surface of which an image has been already formed, waits for forming an image on its back surface next the sheet of paper P1 at a downstream side of the U-turn sheet conveying path 223A. The sheet of paper P3, on a front surface of which an image has been already formed, waits for forming an image on its back surface neat the sheet of paper P2 at the inverse sheet conveying path 227B. The sheet of paper P4, on a front surface of which an image has been already formed, is fixed and will be conveyed to the circular sheet-feeding path 227A. The sheet of paper a P5 fed from a sheet-feeding portion, not shown, waits at the sheet-feeding path 221 for single-side printing.

Here, a case where images are successively formed on front surfaces of the sheets of paper and back surfaces of the sheets of paper when four sheets of paper are conveyed to the image forming apparatus 200 and they are left therein will be explained with reference to FIGS. 2A through 2E. As shown in FIG. 2A, under processing (four sheets left-successive image forming) such that images are successively formed on the front surfaces of the sheets of paper and back surfaces of the sheets of paper when four sheets of paper are conveyed to the image forming apparatus 200 and they sere left therein, the images are successively formed on the front surface of each of the first through fourth sheets of paper, A4 (1) through A4 (4), of A4 size, which are fed from the sheet-feeding path 221 for single-side printing, based on a front surface image forming control signal SG1 shown in FIG. 2B and any image data for front surface, not shown. Next, the front surface image forming control signal SG1 is switched to a back surface image forming control signal SG2 shown in FIG. 2C. Further, images sue successively formed on the back surface of each of the first through fourth sheets of paper, A4 (1) through A4 (4), which are fed from the sheet-feeding path 226 for duplex printing, based on the back surface image forming control signal SG2 and any image data for back surface.

In the image forming apparatus 200, an interval T is set between the sheet-conveying time and the next sheet-conveying time (sheet interval). This interval T corresponds to a period of time between a point of falling time in the back surface image forming control signal SG2 and a point of rising time thereof. This interval T also corresponds to an interval (sheet interval) between an image forming finishing timing when the image is formed on the back surface of the sheet of paper P (A4 (1))fed from the sheet-feeding path 226 for duplex printing to the sheet adjusting portion 220 and an image forming starting timing when the image is formed on the back surface of the other sheet of paper P (A4 (2))next fed from the sheet-feeding path 226 for duplex printing to the sheet adjusting portion 220. This interval T is used as a period of operation time of the conveying rollers 231 in the sheet conveying portion 230 from their release condition to their contact condition and front their contact condition to their release condition.

FIG. 2D shows relationship between acceleration α and time t of the conveying rollers 31. In FIG. 2D, a vertical axis indicates the acceleration α and a horizontal axis indicates the time t which indicates a period of time for releasing or contacting the conveying rollers 231. The solid line shown, in FIG. 2D indicates relationship between acceleration α and time t of the conveying rollers 231 of related art. The broken line shown in FIG. 2D indicates relationship between acceleration α and time t of the conveying rollers of comparison example.

The upward oblique lines indicate the acceleration α when the conveying rollers 231 move from their release condition to their contact condition. The downward oblique lines indicate the deceleration −α when the conveying rollers 231 move from their contact condition to their release condition. In the image forming apparatus 200, the conveying rollers 231 are released and contacted for each of the sheets of paper P (A4 (1) through A4 (4)) fed from the sheet-feeding path 226 for duplex printing.

Such an image forming apparatus 200, however, has the U-turn conveying route 228B with a large radius of curvature before the sheet adjusting portion 220 on the sheet-feeding path 226 for duplex printing. The sheet conveying portion 230 including the conveying rollers 231 and a motor 233 is provided thereon. The sheet of paper passing through the U-turn conveying route 228B with a large radius of curvature has high conveying resistance and a low coefficient of friction (μ) for roller, ort which wax contained toner exert an influence.

Thus, clamping (nipping) pressure by the conveying rollers 231 is set so as to become higher than that of general conveying rollers. Further, the motor 233 driving a contact/release mechanism is placed the heavier load than is usual. In this circumstance, when the pair of registration rollers 223 is moved using the moving mechanism described in the above Japanese Patent Application Publication No. 2007-022680 to correct the deflection of the sheet of paper, a release of the conveying rollers 231 may be required in addition to a release of the pair of upper pair of loop rollers 222.

On the other hand, when the pair of registration rollers 223 is moved during the sheet interval T between the conveyed sheets of paper at the moment of successively forming images on the back surfaces, torque applied to the motor in the contact/release mechanism when contacting or releasing the conveying rollers 231 with higher contact pressure is increased so that the motor may be stepped out. Here, the term, “step-out” of the motor 233 is referred to as such phenomenon that when a load more than a certain level is applied to the motor 233 during a period of operative time thereof, the motor 233 can no longer be rendered operative and returned even if the load is removed.

Also, although it is conceivable that a period of operative time for contact/release is set so as to be longer, it has its limits to set the period of operative time for contact/release so as to be longer in order to render the driven rollers 231b contacted with driving rollers 231a before next sheet of paper P has been reached the conveying rollers 231 while maintaining its productivity.

By the way, in order to keep longer the period of time for contact/release in the sheet conveying portion 230, it is also conceivable to set the period of time for contact/release so as to become longer by adding sufficient timeβto the sheet interval T between the conveyed sheets of paper, as shown in FIG. 2E. However, when the sufficient timeβ is added to the interval T, the period of time between the sheets of paper P fed from the sheet-feeding path 226 for duplex printing to the sheet adjusting portion 220 and the sheet of paper P next fed from the sheet-feeding path 226 for duplex printing to the sheet adjusting portion 220 becomes longer. As a result thereof, productivity of the image forming portion 210 is reduced in the duplex printing mode. In an example shown in FIG. 2D, a period of the operation time of β*N sheets may be required.

Hereinafter, a configuration example, an operation example and a control example of an image forming apparatus according to typical embodiments of this invention will be explained with reference to the drawings. It should be noted that the present invention is not limited to the embodiments described below. Definitions of terms described below are given by way of explanation of the terms only, and thus the definitions of the terms of the invention are not limited thereto.

The following will describe the preferred embodiments to carry out the invention.

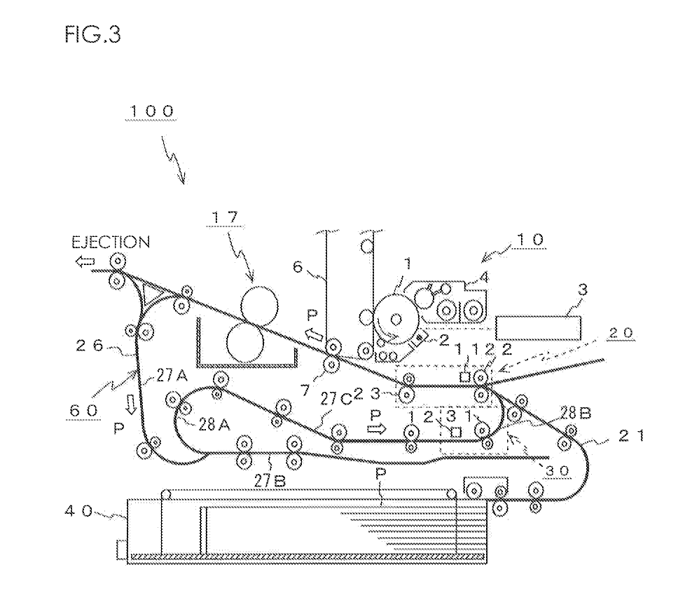

An image forming apparatus 100 shown in FIG. 3 contains a first route through which a sheet of paper is passed in a case of single-side printing mode or the like (hereinafter, referred to as “sheet-feeding path 21 for single-side printing”), a second route through which a sheet of paper is passed in a case of duplex printing mode or the like (hereinafter, referred to as “sheet-feeding path 26 for duplex printing”), an image forming portion 10, a sheet adjusting portion 20, a sheet-conveying portion 30, a sheet-feeding portion 40 and a sheet-inversion mechanism 60.

The sheet-feeding path 21 for single-side printing is a sheet-feeding route extending from the sheet-feeding portion 40 to the sheet adjusting portion 20. A sheet of paper P is conveyed to the image forming position (a transfer position) on the sheet-feeding path 21 for single-side printing when forming the image on one side (front surface) of the sheet of paper P. A sheet-feeding path extending from a manual-bypass tray, not shown, to the sheet adjusting portion 20 also constitutes the sheet-feeding path 21 for single-side printing. The sheet-feeding path 26 for duplex printing is a sheet-feeding route extending from the sheet adjusting portion 20 to the sheet-inversion mechanism 60 and the sheet conveying portion 30 through the image forming portion 10 and back to the sheet adjusting portion 20. The sheet of paper P, on a front surface of which an image has been formed, is inversed on the sheet-feeding path 26 for duplex printing and conveyed back to the image forming position.

For example, the image forming portion 10 forms an image on a front surface of the sheet of paper P conveyed from the sheet-feeding path 21 for single-side printing in case of the duplex printing mode. After fixing processing, the sheet of paper P is then conveyed to the sheet-feeding path 26 for duplex printing. For the image forming portion 10, for example, a color printer is used. The image forming portion 10 has a photosensitive drum 1, a charging unit 2, an optical writing portion 3 and a developing device 4 on every image-forming color (for example, yellow, magenta, cyan or black). In FIG. 3, only one image-forming color is shown. The image forming portion 10 further contains an intermediate transfer belt 6, a transfer portion 7, and a fixing device 17.

The charging unit 2 charges the photosensitive drum 1 to a desired electric potential. The optical writing portion 3 including a printer head of laser scanning type using a polygon mirror and LED array irradiates laser light to the charged photosensitive drum 1 based on image data to expose the photosensitive drum 1 so that an electrostatic latent image can be formed on the photosensitive drum 1. The developing device 4 develops the electrostatic latent image. These charge, exposure and development are performed on each image-forming color so that each toner image can be formed on the photosensitive drums on every image-forming color. The formed toner images are fitted on each other on the intermediate transfer belt 6. The transfer portion 7 transfers the fitted color toner images on the sheet of paper P. the sheet of paper P is conveyed from the sheet-feeding portion 40 to the transfer portion 7.

The fixing device 17 fixes the color toner image transferred on the prescribed sheet of paper P. This allows a color image to be formed on the prescribed sheet of paper P based on the image data. During the duplex printing mode, the fixed sheet of paper P is conveyed to the sheet-feeding path 26 for duplex printing.

Under the fixing device 17, the sheet-inversion mechanism 60 is positioned. In a case of the duplex printing mode (when printing the back surface), the sheet-inversion mechanism 60 inverts the sheet of paper P, on a front surface of which an image has been formed. The sheet-inversion mechanism 60 includes a circular sheet-feeding path 27A, an inverse sheet conveying path 27B and a sheet-feeding path 27C. The circular sheet-feeding path 27A is positioned at a downstream side of the fixing device 17 and the inverse sheet conveying path 27B is positioned at a downstream side or the circular sheet-feeding path 27A.

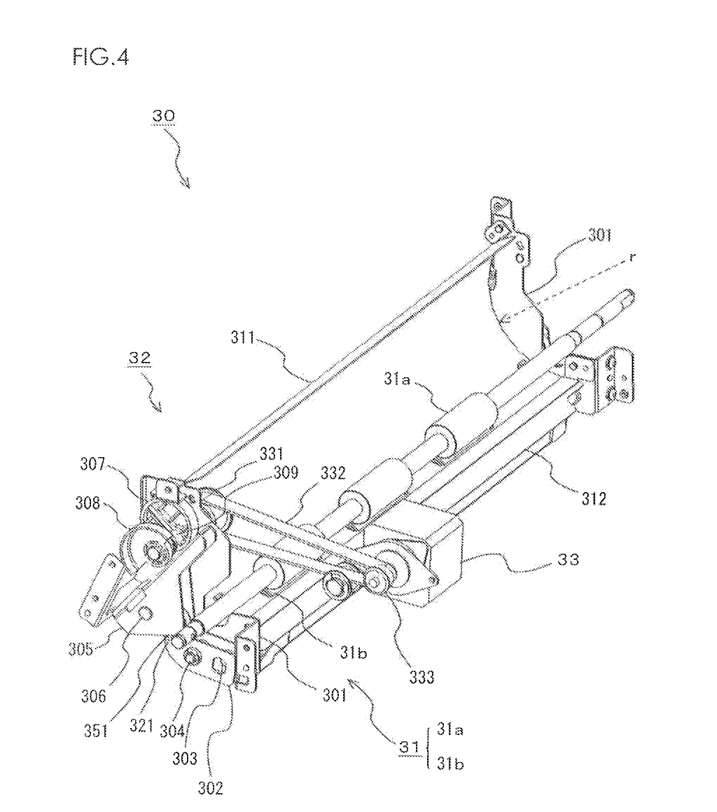

In the inverse sheet conveying path 27B, the sheet of paper P, on a front surface of which an image has been formed, is conveyed with the front surface thereof being faced downward during the duplex printing mode. The inverse sheet conveying path 27B is used as a switchback path (sheet-waiting path) for reversing a sheet-conveying direction of the sheet of paper P. To the inverse sheet conveying path 27B, the sheet-feeding path 27C is continuously connected. The sheet-conveying paths (hereinafter, referred to as “U-turn sheet conveying paths 28A and 28B), each having large U shape with radius of curvature r (see FIG. 4), are positioned at the beginning of the sheet-feeding path 27C and the end thereof.

On the other hand, the sheet adjusting portion 20 is positioned at an upstream side of the image forming portion 10. The sheet adjusting portion 20 adjusts any deflection of the sheet of paper P fed to the image forming portion 10 along a sheet-width direction thereof in relation to the sheet-conveying direction thereof (hereinafter, referred to as “sheet-conveying direction I”). The sheet-width direction is perpendicular to the sheet-conveying direction I. The sheet adjusting portion 20 contains a pair of loop rollers 22 and a pair of registration rollers 23, which sore able to drive separately.

In the sheet adjusting portion 20, a forward end of the sheet of paper P hits against a nip portion formed of the pair of registration rollers 23 by a rotation of the pair of loop rollers 22 just before the image formation. After a posture of the sheet of paper P is corrected toward a direction that is almost perpendicular to the sheet-conveying direction I, the pair of registration rollers 23 is moved along the sheet-width direction with the forward end of the sheet of paper P being nipped by the nipping portion of the pair of registration rollers 23 so that a position of the sheet of paper P can be adjusted. In this condition, the sheet of paper P is conveyed to the transfer portion 7 (registration function). Based on the registration function, it is possible to agree the sheet of paper P conveyed to the image forming portion 10 with the image forming position in the image forming portion 10 in a case of the duplex printing mode so that the images can be accurately formed on both the front and back surfaces of the sheet of paper P alternately.

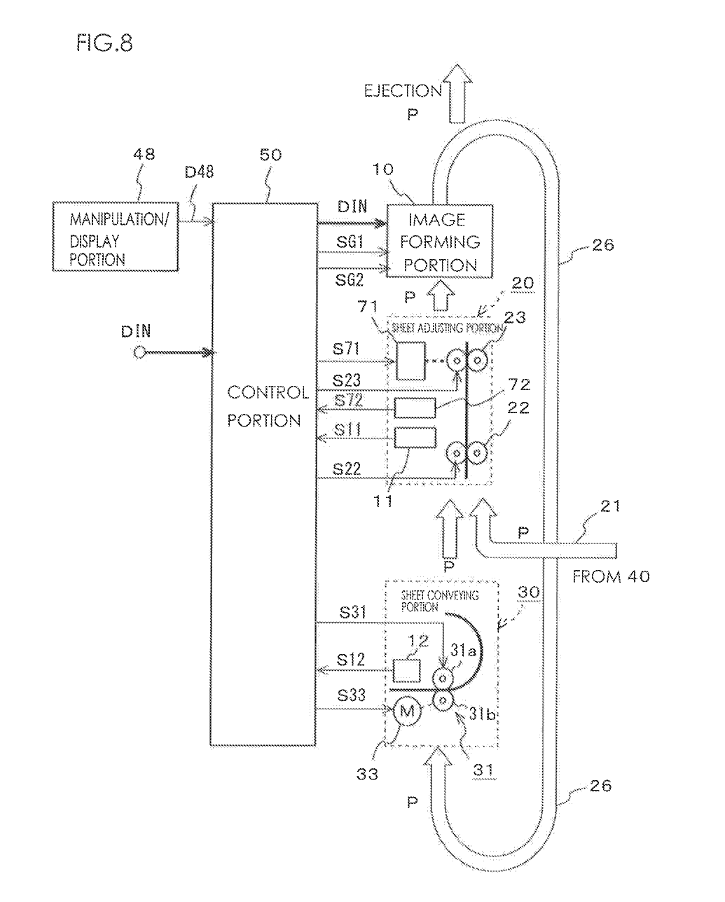

A sheet detection sensor 11 is arranged in the sheet adjusting portion 20. The sheet detection sensor 11 is positioned, for example, at a downstream side of the pair of loop rollers 22. The sheet detection sensor 11 detects the forward end of the sheet of paper P and generates a sheet-reach-detecting signal S11 indicating that the sheet of paper P reaches the sheet adjusting portion 20. The sheet-reach-detecting signal S11 is output to a control portion 50 (see FIG. 8).

At an upstream side of the pair of loop rollers 22 and on the sheet-feeding path 26 for duplex printing, the sheet conveying portion 30 is provided. The sheet conveying portion 30 operates to nip the sheet of paper P, on a front surface of which the image has been formed, by the conveying rollers 31 and to convey the sheet of paper P so the pair of loop rollers 22 via the second U-turn, sheet conveying path 28B which has a large radius of curvature. The conveying rollers 31 may be contacted or released according to the registration operation of the pair of registration rollers 23. The conveying rollers 31 are set so as to be released until the rear end of the sheet of paper is passed through a predetermined position during movement of the pair of registration rollers 23.

In the sheet conveying portion 30, a rear-end detection sensor 12 is provided. The rear-end detection sensor 12 is provided, for example, at an upstream side of the conveying rollers 31. The rear-end detection sensor 12 detects the rear end of the sheet of paper P fed from the sheet adjusting portion 20 to the image forming portion 10 and generates a sheet-rear-end-detecting signal 312 indicating that the sheet of paper P has already passed through the conveying rollers 31. The sheet-rear-end-detecting signal S12 is output to the control portion 50.

The control portion 50 controls the sheet conveying portion 30 to contact the driven rollers 31b on the driving rollers 31a in the sheet conveying portion 30 based on the sheet-rear-end-detecting signal S12 by the rear-end detection sensor 12 when the image forming portion 10 forms the images on both the front and back surfaces of the sheets of paper P alternately during the duplex printing mode. Such a control allows the driven rollers 31b early enough to be contacted with the driving rollers 31a in preparation to the next sheet of paper P.

The following will describe a configuration example and an operation example of the sheet conveying portion 30 with reference to FIGS. 4 and 5. The sheet conveying portion 30 shown in FIG. 2 contains the conveying rollers 31 and a contact/release mechanism 32. The conveying rollers 31 are composed of the driving rollers 31a and the driver rollers 31b. The conveying rollers 31 are configured so that load torque which the driving rollers 31a apply to the driven rollers 31b becomes higher (to 60N) when they are contacted. This higher load torque setting is because the sheet of paper P, on a front surface of which the image has been formed, is subject to being slippery by influence of wax contained in the toner. Accordingly, the sheet of paper P is conveyed on the U-turn sheet conveying path 28B with a large radius of curvature so as to be pushed up with the sheet of paper being nipped under pressure (nipping pressure) by the conveying rollers of about three times higher than the normal pressure by the conveying rollers. Even when the conveying rollers 31 are released, the load torque is set as to be higher because the releasing operation thereof is slowly performed.

The contact/release mechanism 32 contains a motor 33. For the motor 33, a stepping motor is used. For example, well known variable frequency control is applied to the motor 33 and the torque by the motor is controlled so that a width of pulse of one cycle becomes narrower step by step (from low frequency to high frequency). As described later, the contact/release mechanism 32 contacts the driven rollers 31b with the driving rollers 31a or releases the driven rollers 31b from the driving rollers 31a by rotation force of the motor 33. The contact/release mechanism 32 contains right and left member-mounting plates 301, 301, axis-supporting and moving plates 302, 302, a rod junction member 303, bearing portions 304, 304, a link member 305, a rod member 306, a cam member 307, a rotation detecting plate 308 and a cam shaft 303.

Each of the member-mounting plates 301, 301 has almost an L-shape. The member-mounting plates 301, 301 are interconnected by a top link member 311 and a bottom link member 312 so that a main body frame of the sheet conveying portion 30 can be configured. The axis-supporting and moving plates 302, 302, each having almost a J shape, are mounted on the respective member-mounting plates 301, 301 via the rod junction member 303. The axis-supporting and moving plates 302, 302 are configured so as to be movable in relation to the member-mounting plates 301, 301. The bearing portions 304, 304 are provided at predetermined positions of the axis-supporting and moving plates 302, 302. The bearing portions 304, 304 support an axis of the driven roller 31b at right and left ends as to be able to be rotated. An end of one of the axis-supporting and moving plates 302, 302 is configured so as to become a force receiving portion 321.

Between the other of the axis-supporting and moving plates 302, 302 and one of the member-mounting elates 301, 301, a spring coil, not shown, is attached. Urging force of the spring coil (spring constant) sets the driven rollers 31b contact the nipping pressure when the driving rollers 31a. Each of the driving rollers 31a is arranged to face the each of the driven rollers 31b. The driving rollers 31a are supported on the bearing portions, not shown, of the main body of the apparatus so as to be able to be rotated and are driven by a desired motor so as to be rotated. For the driving rollers 31a, rubber rollers are used and for the driven rollers 31b, plastic rollers are used.

The link member 305 having almost b shape containing a straight line part and an angle part is mounted on the one of the member-mounting plates 301, 301 via the rod member 306. The link member 305 is configured so as to be movable in relation to the member-mounting plate 301. The angle part 351 of the link member 305 is configured so as to be a point of action. The angle part 351 of the link member 305 comes into contact with the force receiving portion 321 of the axis-supporting and moving plate 302.

The cam member 307 is mounted at a predetermined position of the member-mounting plate 301 via the cam shaft 302. The cam member 307 is configured so as to be rotatable in relation to the member-mounting plate 301. An outer peripheral edge of the cam member 307 comes into contact with the straight line part of the link member 305. The rotation detecting plate 308 having a semicircle shape is attached to the cam shaft 309.

A pulley 331 is attached to the cam shaft 309. Another pulley 333 is attached to the motor 33. A belt 332 is wound around the pulleys 331, 333. They constitute the contact/release mechanism 32. Thus, the contact/release mechanism 32 contacts the driven rollers 31b with the driving rollers 31a or releases the driven rollers 31b from the driving rollers 31a, under the rotation force of the motor 33.

According to the above-mentioned operation example of the sheet conveying portion 30, the axis-supporting and moving plate 302, the link member 305 and the cam member 307 which are shown by the a solid line in FIG. 5 have a relationship such that the driven rollers 31b contact the driving rollers 31a. In this case, the rotation, detecting plate 308 is positioned up and to the left of the cam shaft 309.

When the cam shaft 309 rotates clockwise starting from the contact condition of the driving rollers 31a and the driven rollers 31b, as shown in FIG. 5, the relationship of the axis-supporting and moving plate 302, the link member 305 and the cam member 307 alters to a relationship which is shown by a brokers line in FIG. 5. For example, when the motor 33 rotates clockwise, the cam member 307 rotates around the cam shaft 309 clockwise by a hemicycle via the belt 332. Such a hemicycle rotation allows the rotation detecting plate 308 to be positioned down and to the right of the cam shaft 309.

In this moment, the cam member 307 pushes down the straight line part of the link member 305, so that the angle part 351 of the link member 305 pushes down the force receiving portion 321 of the axis-supporting and moving plate 302 around the rod member 306. Further, the axis-supporting and moving plates 302, 302 overcome any urging force of the spring coil, not shown to move downward. Such downward movement of the axis-supporting and moving plates 302, 302 allows the driven rollers 31b to be mover downward so that the driving rollers 31a and the driven rollers 31b are released.

When the cam member 307 rotates counterclockwise starting from the release condition, which is shown by the broken line in FIG. 5, of the axis-supporting and moving plate 302, the link member 305 and the cam member 307, the axis-supporting and moving plate 302, the link member 305 and the cam member 307 come back to the their condition shown by the solid line in FIG. 5. For example, when the motor 33 rotates counterclockwise, the cam member 307 rotates around the cam shaft 309 counterclockwise by a hemicycle via the belt 332. Such a hemicycle rotation allows the rotation detecting prate 308 to be positioned up and to the left of the cam shaft 309.

In this moment, the cam member 307 rotates counterclockwise and overcomes any urging force of the spring coil, not shown, so that the force receiving portion 321 of the axis-supporting and moving plate 302 pushes up the angle part 351 of the link member 305. Such pushing-up of the angle part 351 of the link member 305 allows the straight line part of the link member 305 to push up. Further, the axis-supporting and moving plates 302, 302 also move upward. Such upward movement of the axis-supporting and moving plates 302, 302 allows the driven rollers 31b to be moved upward so that the driving rollers 31a and the driven rollers 31b are contacted with each other. Thus, the image forming apparatus 100 having the sheet conveying portion 30 is configured.

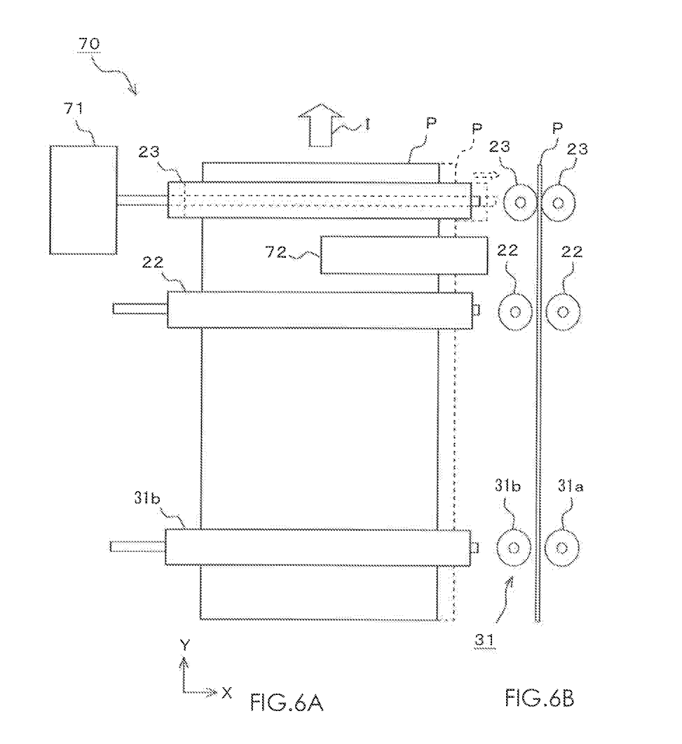

The following will describe a configuration example of a deflection correcting portion 70 and an operation example thereof with reference to FIGS. 6A and 6B. The deflection correcting portion 70 shown in FIG. 6A constitutes the sheet adjusting portion 20 shown in FIG. 3 and has the pair of registration rollers 23, 23, a moving mechanism 71 and a deflection detection sensor 72. The deflection correcting portion 70 has a deflection correction function for correcting the deflection of the sheet of paper P in addition to the registration function.

The moving mechanism 71 moves the pair of registration rollers 23, 23 nipping the sheet of paper P along a sheet-width direction X that is perpendicular to the sheet-conveying direction I of the sheet of paper P. The pair of registration rollers 23, 23, the pair of loop rollers 22, 22 and the conveying rollers 31 (the driving rollers 31a and the driven rollers 31b) are arranged so as to extend along the sheet-width direction X that is perpendicular to the sheet-conveying direction I of the sheet of paper P. The driving rollers 31a and the driver rollers 31b are positioned at a predetermined positron below the pair of registration rollers 23, 23 and the pair or loop rollers 22, 22. Here, for convenience, the conveying rollers 31 (the driving rollers 31a and the driven rollers 31b) are shown so that they could be unfolded on the same level as the pair of registration rollers 23, 23 and the pair of loop rollers 22, 22.

The moving mechanism 71 is attached to a base plate supporting the shaft of the pair of registration rollers 23, 23. The moving mechanism 71 moves the pair of registration rollers 23, 23 along the sheet-width direction X on the basis of the sheet-conveying direction I (=Y direction). A motor, not shown, is attached to the moving mechanism 71. By rotation force of the motor, the pair of registration rollers 23, 23 is moved toward right or left along the sheet-width direction X.

The deflection detection sensor 72 is provided between the pair of loop rollers 22, 22 and the pair of registration rollers 23, 23. The deflection detection sensor 72 detects any difference between a reference position and an end of the sheet of paper along the sheet-conveying direction I and generates a deflection detection signal S72. The deflection detection signal S72 is output to the control portion 50. The control portion 50 controls the moving mechanism 71 to move the sheet of paper P on which the registration processing has been performed to right or left along the sheet-width direction X with the sheet of paper P being nipped by the pair of registration rollers 23, 23 so that the difference between the reference position and the end of the sheet of paper P could not exist.

In this embodiment, the control portion 50 controls the moving mechanism 71 to move the sheet of paper P from the position illustrated by the solid line to the position illustrated by the broken line. In this registration moving moment, as shown in FIG. 6B, the pair of loop rollers 22, 22 and the conveying rollers 31 said the like positioned at upstream side from the pair of registration rollers 23, 23 are configured as to be released. The pair of loop rollers 22, 22 and the conveying rollers 31 and the like are released so that the sheet P is made free except the forward end thereof nipped by the pair of registration rollers 23, 23. This enables the sheet of paper P to be easily moved to right or left along the sheet-width direction X.

Thus, the deflection correcting portion 70 having the moving mechanism 71 is configured, so that the deflection of the sheet of paper P can be corrected when the image forming portion 10 forms the image on the front surface and the back surface of the sheet of paper P alternately during the duplex printing mode.

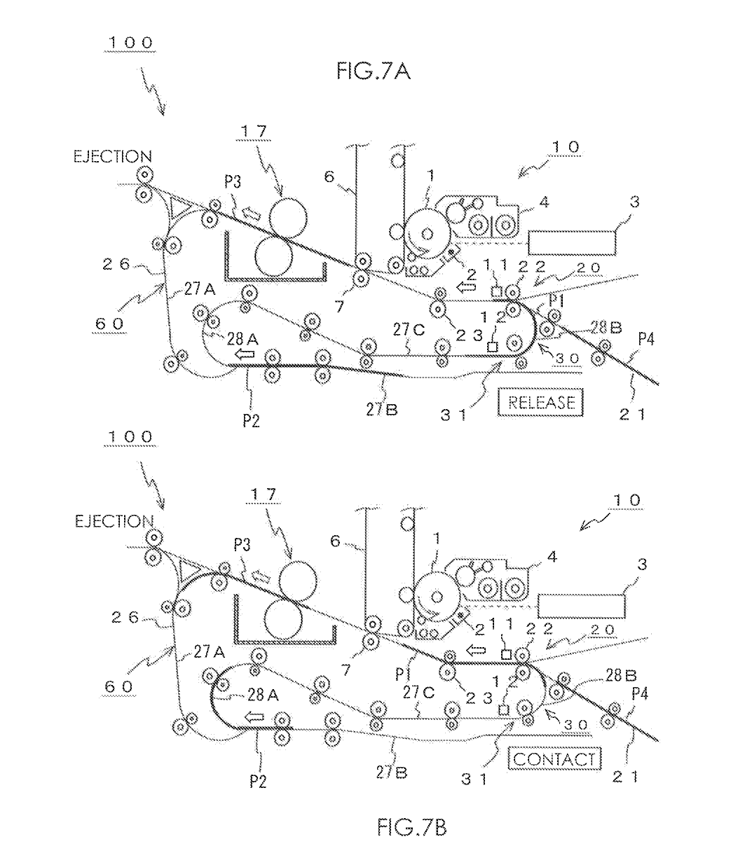

The following will describe a case where images are alternately formed on the front surface of each of the sheets of paper P and the back surface of each of the sheets of paper P when three sheets of paper are conveyed to the image forming apparatus 100 and they are left therein with reference to FIGS. 7A and 7B. A released case of the conveying rollers 31 shown in FIG. 7A when three sheets of paper P are conveyed to the image forming apparatus 100 and they are left therein is under the condition such that the sheet of paper P1, on a front surface of which an image has been already formed, waits for forming an image on its back surface during the duplex printing mode. In this moment, the conveying rollers 31 have been already released. Three sheets of paper P1 through P3 are left in the sheet-feeding path 26 for duplex printing. The conveying rollers 31 start releasing slowly at the same time when the sheet detection sensor 11 detects the forward end of the sheet of paper P1. The sheet adjusting portion 20 performs the registration processing and the deflection correction processing.

In this embodiment, the sheet of paper P1, on a front surface of which an image has been formed, is left on a route from the sheet-feeding path 27C to the pair of loop rollers 22. The forward end of the sheet of paper P1 is nipped by the pair of loop rollers 22 and the rear end thereof is left at an upstream side of a rear-end detection sensor 12. In such a condition, the sheet of paper P1 waits for forming an image on the back surface thereof. The sheet of paper P2, on a front surface of which an image has been already formed, waits for forming an image on its back surface next the sheet of paper P1 on the inverse sheet conveying path 27B. The sheet of paper P3, on a front surface of which an image has been already formed, is fixed and will be conveyed to the circular sheet-feeding path 27A. The sheet of paper P4 fed from the sheet-feeding portion 40 waits at the sheet-feeding path 21 for single-side printing.

A contact case of the conveying rollers 31 shown in FIG. 7B when three sheets of paper P are conveyed to the image forming apparatus 100 and they are left therein is under the condition just before the image forming portion 10 forms an image on the back surface of the sheet of paper P1, on a front surface of which an image has been already formed during the duplex printing mode. In this moment, the rear end of the sheet of paper P passes through the conveying rollers 31. After the rear end of the sheet of paper P passes through the conveying rollers 31, the conveying rollers 31 start a contact operation. The rear-end detection sensor 12 detects whether or not the rear end of the sheet of paper P passes through the conveying rollers 31. In this embodiment, the sheet of paper P2 next the sheet of paper P exists on the first U-turn sheet conveying path 28A. The conveying rollers 31 performs any slower contact operation, compared with the previous one, utilizing a period of time until the sheet of paper P2 is reached and completes the contact operation.

The sheet of paper P2 existed on the inverse sheet conveying path 27B, as shown in FIG. 7B, is then conveyed from the first U-turn sheet conveying path 28A to the second U-turn sheet conveying path 28B of the sheet-feeding path 27C. The sheet P2 then waits for forming an image on the back surface thereof at the U-turn sheet conveying path 28B, as shown in FIG. 7A. The sheet of paper P3, on a front surface of which an image has been formed, is fixed and conveyed to the circular sheet-feeding path 27A below the fixing device 17. The sheet of paper P3 then waits for forming an image on its back surface on the inverse sheet conveying path 27B, as shown in FIG. 7A.

The sheet of paper P4 which is fed from the sheet-feeding portion 40 and waits at the sheet-feeding path 21 for single-side printing is then conveyed to the sheet adjusting portion 20. The image forming portion 10 then forms the image on the front surface of the sheet of paper P4. Thus, when three sheets of paper are conveyed and left in the image forming apparatus 100, it is possible to form the images on the front surface and the back surface of each of the sheets of paper P1 through P3 alternately.

The following will describe a configuration example of a control system of the image forming apparatus 100 with reference to FIG. 8. The control system of the image forming apparatus 100 shown in FIG. 8 includes a manipulation/display portion 48 and the control portion 50 to form the image on the front surface and the back surface of each of the sheets of paper P1 through P3 alternately when three sheets of paper are conveyed and left in the image forming apparatus 100.

The manipulation/display portion 48 is connected with the control portion 50 and allows a user to be manipulated when setting image forming jobs, image forming conditions, sheet-feeding conditions and the like. For example, the user manipulates the manipulation/display portion 48 to set the duplex printing mode as the image forming job. In the duplex printing mode, the images are respectively formed on the front and back surfaces of each of the sheets of paper P and output. The manipulation/display portion 48 outputs the set image forming condition or the like as manipulation data D48 to the control portion 50.

The control portion 50 controls the sheet adjusting portion 20 to convey the sheets of paper P, which are fed from the sheet-feeding path 21 for single-side printing, and the sheets of paper P, which are fed from the sheet-feeding path 26 for duplex printing, alternately to the image forming portion 10 during the duplex printing mode. The control portion 50 also controls the sheet conveying portion 30 to release the contact of the driving rollers 31a and the driven rollers 31b in the sheet conveying portion 30 after it is detected that the sheet of paper P reaches the sheet adjusting portion 20.

Further, the control portion 50 controls the image forming portion 10 to alternately form the images on the front surface of each of the sheets of paper P, which are fed from the sheet-feeding path 21 for single-side printing, and the back surface of each of the sheets of paper P, which are fed the sheet-feeding path 26 for duplex printing. Under such a control, it is possible to maintain an interval between the sheet of paper P, which is fed from the sheet-feeding path 26 for duplex printing to the sheet adjusting portion 20, and the sheet of paper P, which is next fed from the sheet-feeding path 26 for duplex printing to the sheet adjusting portion 20 by a period of time when the image is formed on the sheet of paper P fed from the sheet-feeding path 21 for single-side printing.

The image forming portion 10 is connected with the control portion 50. The image forming portion 10 receives image data DIN for front surface image and back surface image from the control portion 50. The image forming portion 10 also receives the front surface image formation control signal SG1 and the back surface image formation control signal SG2 alternately from the control portion 50. The front surface image formation control signal SG1 is a signal for allowing an image to be formed on the front surface of the sheet of paper P. The back surface image formation control signal SG2 is a signal for allowing an image to be formed on the back surface of the sheet of paper P. The image forming portion 10 forms the image on the front surface of the sheet of paper P based on the front surface image formation control signal SG1 and forms the image on the back surface of the sheet of paper P based on the back surface image formation control signal SG2.

The sheet detection sensor 11, the moving mechanism 71 and the deflection detection sensor 72 are connected to the control portion 50. To the pair of loop rollers 22, a motor, not shown, is connected and the motor rotates the pair of loop rollers 22 to a predetermined rotation direction based on a roller driving signal S22. The roller driving signal S22 is a signal for allowing the pair of loop rollers 22 to be driven and is output to the motor from the control portion 50 during the registration correction.

To the pair of registration rollers 23, a motor, not shown, is also connected and the motor rotates the pair of registration, rollers 23 to a predetermined rotation direction based on a roller driving signal S23. The roller driving signal S23 is a signal for allowing the pair of registration rollers 23 to be driven and is output to the motor from the control portion 50 during the image transfer.

The sheet detection sensor 11 detects the forward end of the sheet of paper P at the downstream side of the pair of loop rollers 22 and outputs a sheet-reach-detecting signal S11 to the control portion 50. The deflection detection sensor 72 outputs to the control portion 50 the deflection detection signal S72 obtained by detecting the difference between a side end of the sheet of paper P and the reference position.

The control portion 50 outputs a movement control signal S71 to the moving mechanism 71 to perform the deflection correction of the sheet of paper P. The movement control signal S71 is a signal for allowing the sheet of paper P on which any registration processing is performed to be moved to right or left so that the difference between a side end of the sheet of paper P and the reference position does not exist. The control portion 50 outputs the movement control signal S71 to the motor, not shown, of the moving mechanism 71.

This moving mechanism 71 moves the sheet of paper P nipped by the pair of registration rollers 23 to right or left along the sheet-width direction X. The sheet detection sensor 11, the pair of loop rollers 22, the pair of registration rollers 23, the moving mechanism 71 and the deflection defection sensor 72 constitute the sheet adjusting portion 20.

The rear-end detection sensor 12, the conveying rollers 31 and the motor 33 are also connected to the control portion 50. The rear-end detection sensor 12 detects the rear end of the sheet of paper P at the upstream side of the conveying rollers 31. The rear-end detection sensor 12 outputs the sheet-rear-end-detecting signal 312 to the control portion 50. The control portion 50 receives the sheet-rear-end-detecting signal S12 and controls the motor 33 to shift the conveying rollers 31 from their release condition to their contact condition when detecting that the sheet of paper P passes through the conveying rollers 31.

For example, the control portion 50 outputs a motor control signal S33 to the motor 33 and controls the motor 33 to shift the conveying rollers 31 from their release condition to their contact condition. The motor control signal S33 is a signal for setting a period of time from the release of the conveying rollers 31 to their contact to be longer (decreasing the acceleration) when the conveying rollers 31 are shifted from their release condition to their contact condition. The control portion 50 outputs the motor control signal S33 to the motor 33. The motor control signal S33 is also a signal for setting a period of time from the contact of the conveying rollers 31 to their release to be longer (decreasing the acceleration) when the conveying rollers 31 are shifted from their contact condition to their release condition. By setting the period of time from the contact to the release of the conveying rollers 31 to be longer, it is possible to prevent the motor 33 from Being stepped out.

It is to be noted that the driving rollers 31a rotate based on a motor control signal S31 by a motor, not shown. The motor control signal S31 is a signal for conveying the sheet of paper, on the front surface of which the image has been formed, by pushing up it from the U-turn sheet conveying path 28A to the sheet adjusting portion 20. The control portion 50 outputs the motor control signal S31 to a motor, not shown, of the sheet conveying portion 30. The rear-end detection sensor 12, the conveying rollers 31 and the motor 33 constitute the sheet corn/eying portion 30.

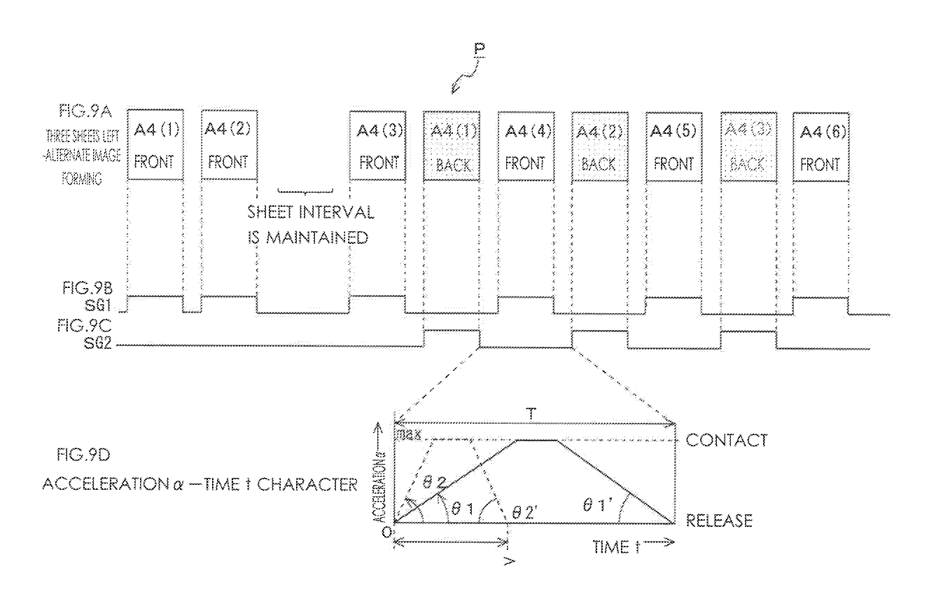

The following will describe an operation example or the image forming apparatus 100 in which three sheets of paper are left and images are alternately formed on the front surface of each of the sheets of paper and the back surface of each of the sheets of paper, with reference to FIGS. 9A through 9D. In this embodiment, during the duplex printing mode, the period of time from the contact of the conveying rollers 31 to their release is set as to be longer (by decreasing the acceleration) in order to prevent the motor 33 from being stepped out when the conveying rollers 31 having high contact pressure is shifted from their contact condition to their release condition. The interval for preventing the next sheet of paper from being reached is maintained when the release and contact is performed in the sheet conveying portion 30 by feeding the sheets of paper P alternately from the sheet-feeding path 21 for single-side printing and the sheet-feeding path 26 for duplex printing.

According to the processing shown in FIG. 9A for forming the images on the front surface of each of the sheets of paper P and the back surface of each of the sheets of paper P alternately when three sheets of paper are left in the image forming apparatus 100, after the image is formed on the front, surface of a first sheet of paper P (A4 (1)) of A4 size, images are alternately formed on the front surface of each of the sheets of paper P fed from the sheet-feeding path 21 for single-side printing and the back surface of each of the sheet of paper P fed from the sheet-feeding path 26 for duplex printing during the intermediate image forming process except for the opening three sheets of paper and the last three sheets of paper.

In this embodiment, the image for front surface (hereinafter, referred to as “front surface image”) is formed on the front surface of the first sheet of paper P (A4 (1)) fed from the sheet-feeding path 21 for single-side printing based on the front surface image forming control signal SG1 shown in FIG. 9B and image data DIN for front surface, not shown. Next, a front surface image is formed on the front surface of the second sheet of paper P (A4 (2)) based on the front surface image forming control, signal SG1 and the image data DIN. An interval for avoiding conveying one sheet of paper is then maintained. Further, a front surface image is formed on the front surface of the third sheet of paper P (A4 (3))based on the front surface image forming control signal SG1 and the image data DIN.

The sheet interval T between the second sheet of paper P (A4 (2)) and the third sheet of paper P (A4 (3)) is maintained because the sheet interval T, namely, a period of time for forming an image on the fourth sheet of paper P (A4 (4)) fed from the sheet-feeding path 21 for single-side printing is maintained between an image forming timing of forming an image on the back surface of the first sheet of paper P (A4 (1)) fed from the sheet-feeding path 26 for duplex printing to the sheet adjusting portion 20 and an image forming timing of forming an image on the back surface of the second sheet of paper P (A4 (2)) fed from the sheet-feeding path 26 for duplex printing to the sheet adjusting portion 20. In this embodiment, the above-mentioned sheet interval T corresponds to a period of operation time when the conveying rollers 31 are shifted from their release condition to their contact condition and back to their release condition in the sheet conveying portion 30.

The front surface image forming control signal SG1 is switched to the back surface image forming control signal SG2 shown in FIG. 9C. The image for back surface (hereinafter, referred to as “back surface image”) is formed on the back surface of the first sheet of paper P (A4 (1)) fed from the sheet-feeding path 26 for duplex printing based on the back surface image forming control signal SG2 and image data DIN for back surface. Next, the back surface image forming control signal SG2 is switched to the front surface image forming control signal SG1. The front surface image is formed on the front surface of the fourth sheet of paper P (A4 (4)) fed from the sheet-feeding path 21 for single-side printing based on the front surface image forming control signal SG1 and image data DIN for front surface.

The front surface image forming control signal SG1 is then switched to the back surface image forming control signal SG2. The back surface image is formed on the back surface of the second sheet of paper P (A4 (2)) fed from the sheet-feeding path 26 for duplex printing based on the back surface image forming control signal SG2 and image data DIN for back surface. Further, the back surface image forming control signal SG2 is switched to the front surface image forming control signal SG1. The front, surface image is formed on the front surface of the fifth sheet of paper P (A4 (5)) fed from the sheet-feeding path 21 for single-side printing based on the front surface image forming control signal SG1 and image data DIN for front surface.

The front surface image forming control signal SG1 is then switched to the back surface image forming control signal SG2. The back surface image is formed on the back surface of the third sheet of paper P (A4 (3)) fed from the sheet-feeding path 26 for duplex printing based on the back surface image forming control signal SG2 and image data DIN for back surface. Further, the back surface image forming control signal SG2 is switched to the front surface image forming control signal SG1. The front surface image is formed on the front surface of the sixth sheet of paper P (A4 (6)) fed from the sheet-feeding path 21 for single-side printing based on the front surface image forming control signal SG1 and image data DIN for front surface. Thus, successively, the images are alternately formed on the front surface of each of the sheets of paper P fed from the sheet-feeding path 21 for single-side printing and the back surface of each of the sheets of paper P fed from the sheet-feeding path 26 for duplex printing.

FIG. 9D shows relationship between acceleration α and time t of the conveying rollers 31. In FIG. 9D, a vertical axis indicates the acceleration α and a horizontal axis indicates the time t which indicates a period of time for releasing or contacting the conveying rollers 31. The broken line shown in FIG. 9D indicates relationship between acceleration α and time t of the conveying rollers 31 of related art. The solid line shown in FIG. 9D indicates relationship between acceleration α and time t of the conveying rollers 31 of the embodiment of this invention. Both the upward oblique lines indicate the acceleration α when the conveying rollers 31 move from their release condition to their contact condition. Both the downward oblique lines indicate the deceleration −α when the conveying rollers 31 move from their contact condition to their release condition.

In this embodiment, inclinations are set so as to become gentler than those of the related arc in order to make longer each period of operative time from the release condition to the contact condition of the conveying rollers 31 and from the contact condition to the release condition of the conveying rollers 31. Such gentle inclinations (by decreasing acceleration) enable the motor 33 to avoid being stepped out. In other words, if the inclinations of the acceleration when the conveying rollers 31 switch their release condition to their contact condition are respectively θ1 and θ2 in this embodiment and the related art and the inclinations of the acceleration when the conveying rollers 31 switch their contact condition to their release condition are respectively θ1′ and θ2′, the inclinations of acceleration are set as to be θ1>θ2 and θ1′>θ2′.

According to the image forming apparatus 100 as the embodiment of the invention, the control portion 50 controls the sheet adjusting portion 20 to alternately convey the sheet of paper P fed from the sheet-feeding path 21 for single-side printing and the sheet of paper P fed from the sheet-feeding path 26 for duplex printing to the image forming portion 10 during the duplex printing mode. The control portion 50 also controls the motor 33 of the sheet conveying portion 30 to release the contact of driven rollers 31b to the driving rollers 31a in the sheet conveying portion 30 after it is detected that the sheet of paper P reaches the sheet adjusting portion 20. The control portion 50 further controls the image forming portion 10 to form an image on the front surface of each of the sheers of paper P fed from the sheet-feeding path 21 for single-side printing and an image on the back surface of each of the sheets of paper P fed from the sheet-feeding path 26 for duplex printing alternately by outputting the front surface image forming control signal SG1 and the back surface image forming control signal SG2 to the image forming portion 10.

Under these controls, during the duplex printing mode, it is possible to maintain the sheet interval T by a period of time when an image is formed on the sheet of paper P fed from the sheet-feeding path 21 for single-side printing between the sheet of paper P fed from the sheet-feeding path 21 for single-side printing to the sheet adjusting portion 20 and the other sheet of paper P next fed from the sheet-feeding path 26 for duplex printing to the sheet adjusting portion 20. Accordingly, when the sheet of paper P is next conveyed from the sheet-feeding path 26 for duplex printing to the sheet adjusting portion 20 and the deflection of the sheet of paper P is adjusted in the sheet adjusting portion 20, the sheet interval T can be used as the period of operative time from the release condition to the contact condition of the conveying rollers 31 in the sheet conveying portion 30 and from the contact condition to the release condition of the conveying rollers 31 in the sheet conveying portion 30. By utilizing the period of operative time from the release condition to the contact condition of the conveying rollers 31 in the sheet conveying portion 30 and from the contact condition to the release condition of the conveying rollers 31 in the sheet conveying portion 30, it is possible to have enough time for releasing the driven rollers 31b from the driving rollers 31a in the sheet conveying portion 30 and contacting them in the sheet conveying portion 30. This enables the motor 33 of the sheet conveying portion 30 to avoid being stepped out. It is thus possible to keep the productivity and enhance the reliability during sheet conveying control time.

Although, in the above-mentioned embodiments, the sheet adjusting portion 20 has been described so as to be provided with the pair of loop rollers 22, the pair of registration rollers 23 and the moving mechanism for moving the pair of registration rollers 23, this invention is not limited thereto. For example, the sheet adjusting portion 20 may be provided with plural pairs of conveying rollers in which one pair of conveying rollers is driven independently of the other pair of conveying rollers and the sheet adjusting portion adjusts the deflection of the shoot of paper nipped by the plural pairs of conveying rollers. In this case, by driving the respective pairs of conveying rollers at different rotation speeds, it is possible to convey the sheet of paper P to the image forming start position with the bent sheet of paper being straightened or the sheet of paper being adjusted, which enables the image to be formed on the sheet of paper P with accuracy.

This invention is preferably applied to a color printer, a black/white printer, a copying machine, a multifunction printer thereof or like, which have a control function of feeding the sheets of paper from the sheet-feeding path 21 for single-side printing and from the sheet-feeding path 26 for duplex printing alternately, during the duplex printing mode.

It should be understood by those skilled in the art that various modifications, combinations, sub-combinations and alterations may occur depending on design requirements and other factors insofar as they are within the scope of time appended claims tor the equivalents thereof.

What is claimed is:

1. An image forming apparatus comprising:
an image forming portion that forms an image on a sheet of paper;
a first route that feeds the sheet of paper to the image forming portion;
a second route that feeds again the sheet of paper, a surface of which the image is formed, to the image forming portion;
a sheet adjusting portion that adjusts a deflection of the sheet of paper along a sheet-width direction that is perpendicular to a sheet conveying direction of the sheet of paper fed to the image forming portion;
a sheet conveying portion that conveys the sheet of paper, a surface of which the image is formed, to the sheet adjusting portion by conveying rollers, the sheet conveying portion being provided on the second route at an upstream side of the sheet adjusting portion; and
a control portion that is configured to control the sheet adjusting portion and the sheet conveying portion,
wherein, during a duplex printing mode, the control portion controls the sheet adjusting portion to alternately feed the sheet of paper fed from the first route and the sheet of paper fed from the second route to the image forming portion and the control portion controls the sheet conveying portion to release the contact of the conveying rollers after it is detected that the sheet of paper reaches the sheet adjusting portion.

2. The image forming apparatus according to claim 1 wherein the control portion controls the image forming portion to alternately form an image on a surface of the sheet of paper fed from the first route surd an image on the other surface of the sheet of paper fed from the second route.

3. The image forming apparatus according to claim 1 further comprising a sheet detecting portion that detects a rear end of the sheet of paper, the sheet detecting portion being provided at upstream side of the sheet conveying portion, wherein the control portion controls the sheet conveying portion to contact the conveying rollers based on sheet-rear-end-detection information by the sheet detecting portion.

4. The image forming apparatus according to claim 3 wherein the sheet adjusting portion includes a pair of registration rollers and a pair of loop rollers; and
a forward end of the sheet of paper nipped by the loop rollers hits against a nipping portion formed of the pair of registration rollers to correct the deflection of sheet of paper.

5. The image forming apparatus according to claim 4 wherein the pair of registration rollers includes a moving mechanism that moves the sheet of paper along the sheet-width direction that is perpendicular to the conveying direction of the sheet of paper with the sheet of paper being nipped.

6. The image forming apparatus according to claim 1 wherein the sheet adjusting portion includes plural pairs of conveying rollers, and
one pair of conveying rollers is driven independently of the other pair of conveying rollers and the sheet adjusting portion adjusts the deflection of the sheet of paper nipped by the plural pairs of conveying rollers.
